(19) United States
(12) Patent Application Publication
(10) Pub. No.: US 2026/0131648 A1
(43) Pub. Date: May 14, 2026

(54) DRIVE, TRANSPORT VEHICLE, AND USE

(71) Applicant: STXI Motion Ltd, Petach Tikva (IL)

(72) Inventors: Henrik Vollhardt, Petach Tikva (IL); Markus Erlich, Petach Tikva (IL)

(21) Appl. No.: 19/382,947

(22) Filed: Nov. 7, 2025

(30) Foreign Application Priority Data
Nov. 9, 2024 (EP) 24211940.2

(51) Int. Cl. B60K 17/04; B60B 21/02; B60B 27/00; B60K 7/00; B60T 1/06; B60T 13/74; F16H 1/28; F16H 57/08; F16H 57/10

(52) U.S. Cl. CPC B60K 17/046; B60B 21/02; B60B 27/0052; B60K 7/0007; F16H 1/28; F16H 57/082; F16H 57/10; B60K 2007/0092; B60T 1/065; B60T 13/746

(57) ABSTRACT

A drive for a wheel-driven vehicle, includes a planetary gear system which includes a sun gear, a ring gear, a planet carrier, and planet gears carried by the planet carrier and meshing with the sun gear and the ring gear. The drive includes an electric motor for driving the sun gear and a wheel which is non-rotatably connected to the ring gear. The drive further includes an electromechanical brake for braking the sun gear and/or a drive shaft of the electric motor. The sun gear is arranged between the brake and the electric motor and/or the brake is being accommodated by an axial cut-out of the planetary gear system.

The present application is based upon and claims the right of priority to EP Patent Application No. 24211940.2, filed on Nov. 9, 2024, the disclosure of which is hereby incorporated by reference herein in its entirety for all purposes.

The following aspects related to a drive for a wheel-driven vehicle, wherein the drive comprises a planetary gear system, an electric motor, and a wheel, to a driverless transport vehicle comprising a drive, and to a use of a drive.

It is known from the prior art that wheel-driven vehicles require drives that ensure high efficiency and reliability. However, known drives have disadvantages with respect to the design complexity and efficiency thereof. Furthermore, known drives are comparatively large or not very compact.

It is therefore an object to provide solutions that not only ensure efficient power transmission, but also enable a compact integration. In particular, the disadvantages of the prior art are to be avoided or at least substantially reduced.

The present object is achieved by the features of the independent claims. Advantageous embodiments are defined in the dependent claims, the description, and the drawings. As far as technically possible, the disclosures of the description, the drawings, and the claims can be combined with one another as desired.

In particular, the object is achieved by a drive for a wheel-driven vehicle, comprising
a planetary gear system including a sun gear, a ring gear, a planet carrier, and planet gears carried by the planet carrier and meshing with the sun gear and the ring gear;
an electric motor for driving the sun gear;
a wheel which is non-rotatably connected to the ring gear; and
an electromechanical brake for braking the sun gear and/or a drive shaft of the electric motor providing the sun gear,
wherein the sun gear is arranged between the brake and the electric motor and/or the brake is accommodated by an axial cut-out of the planetary gear system and/or by the wheel or in the wheel.

In other words, for example, the invention relates to an electric wheel drive. The wheel drive comprises a motor and an epicyclic gear including a sun gear driven by the motor, a ring gear, and a planet carrier holding several planet gears which are in engagement with the sun gear and the ring gear. The ring gear is directly or indirectly connected to a wheel or tire, for example a rubber tire or plastic tire, which transmits the driving force originating from the motor and transmitted via the epicyclic gear to the ground. In addition, a brake is provided, which can introduce a braking force into the wheel via the planetary gear system. The brake is compactly arranged in the wheel or away from the electric motor, making it accessible particularly well.

The proposed solution is intended to create as compact a drive as possible. By al-lowing the wheel to rotate together with the ring gear or being non-rotatably connected thereto, and in particular not to the planet carrier or the sun gear, the axial length of the drive can be reduced. Essentially, the wheel can surround the ring gear and be directly or indirectly connected thereto in a torque-transmitting manner.

The non-rotatable connection between the wheel and the ring gear makes the best possible use of the available radial installation space. In particular, bearings and further components can be positioned in a space-saving manner, and a reduction in the axial length can be achieved.

For example, in known drives, the planet carrier is often connected to the wheel, while the electric motor is connected to the sun gear. In most instances, the ring gear is provided so as to be stationary and, in particular, is fixedly connected to the electric motor. Deviating from this known concept, with the development of invention it was recognized that it is possible to connect the ring gear non-rotatably to the wheel. In particular, in a double cheek plate planet carrier, a respective bearing can be arranged on one of the cheek plates of the planet carrier, so that high radial loads are possible and a bending moment or a tilting moment at the drive can be reduced.

Depending on the design, the proposed solution may allow access to the planetary gear system through the wheel, for example for maintenance purposes. The brake is arranged so as to be easily accessible for maintenance.

A drive refers, for example, to a device or system that is used to provide a driving force or torque to one or more wheels or traction wheels of a vehicle. In particular, the drive is a wheel hub drive, wheel hub motor, or hub gear motor. Typically, the drive can convert electrical energy into mechanical and thermal energy. The drive can comprise various mechanical and electrical components which interact to enable locomotion of a vehicle. For example, the drive comprises at least one motor, at least one wheel, and at least one transmission for connecting the motor to the wheel. The drive, in particular the motor and/or transmission, can have a structural design so as to bear part of the vehicle weight. The type of vehicle includes, in particular, vehicles that can be driven by or on wheels or traction wheels. A wheel-driven vehicle shall, for example, be understood to mean a vehicle in which the locomotion of the vehicle is effectuated by driving one or more of the traction wheels thereof. For example, the vehicle is configured to be self-driving or for driverless driving.

A planetary gear system or epicyclic gear system is a gear system in which one gear wheel or planet gear engages or several gear wheels or planet gears engage in a central gear wheel or pinion or sun gear, while at the same time engaging in an outer gear wheel or ring gear. In particular, a single-stage planetary gear system is provided, with a two-stage or multi-stage planetary gear also being possible. The sun gear and/or ring gear can be formed by a section of a shaft, for example a drive shaft or motor shaft, or can be mounted thereto. The sun gear can be designed to be integral with the drive shaft. The planet gears, usually two, three, or more, are typically held rotatably in parallel to one another by a planet carrier. The sun gear, the planet carrier, and/or the ring gear can define an axis of rotation of the gear system. The planet gears can typically rotate parallel to the axis of rotation.

The planetary gear system is used in particular for transmitting and converting torque and rotational speeds. It is characterized by a compact design and a wide range of gear ratios. For example, a driving torque can be coupled into the sun gear and the wheel can be connected to the planet carrier or the ring gear, wherein the ring gear or planet carrier can be arranged so as to be stationary.

The planetary gear system is preferably involute-toothed. Preferably, easy-to-produce straight teeth are provided. Helical teeth are also possible, for example to reduce noise. Further preferably, regardless of whether straight or helical teeth are present, modified involute teeth are provided so as to simplify the production of the teeth. Typically, the teeth are made of steel to ensure maximum durability.

The sun gear can be driven, in particular directly, by the electric motor. The ring gear surrounds, for example, the planet gears and the sun gear and meshes directly with the planet gears. In particular, the planet carrier holds the planet gears, which can mesh simultaneously with the sun gear and the ring gear.

The electric motor or electric machine converts electrical energy into mechanical energy or a rotational movement. The motor is preferably connected directly or indirectly to the sun gear and, with the rotational movement thereof, ensures that the planetary gear system is being driven. Typically, the electric motor is designed as a synchronous motor or, alternatively, as an asynchronous motor or DC motor. The electric motor is typically driven by a servo converter or inverter.

The wheel is to ensure, for example, the transmission of power from the electric motor via the planetary gear system to the ground so as to move the vehicle. The wheel can have a rim and a wheel tread placed on or applied to the rim. The wheel is directly or indirectly non-rotatably connected to the ring gear of the planetary gear system, for example so that the rotational movement of the ring gear can be transmitted to the wheel directly or without change. For example, the wheel is made of a flexible material, for example, plastic, rubber or elastomer material and/or polyurethane elastomer or highly elastic, cross-linked polyurethane elastomer, so as to ad-here to the ground. The wheel can have a profile or tread on the outside or be designed as a slick.

Advantageous aspects and preferred modifications are described and explained in the present example. Explanations, in particular regarding advantages and definitions of features, are by nature descriptive and preferred, but non-limiting examples. If an explanation is limiting, this is expressly mentioned.

As an alternative or in addition, it may be provided that the drive comprises at least two bearings for mounting the ring gear on or relative to the planet carrier. The at least two bearings can be arranged on the planet carrier. More than two bearings may be provided. For example, roller bearings, sliding bearings, and/or other bearings can be provided as bearings. In particular, ball bearings, grooved ball bearings, roller bearings, cylindrical roller bearings, spherical roller bearings, needle bearings, tapered roller bearings, thin-section bearings, and/or other bearings are provided as rolling bearings. A rolling bearing typically comprises an inner ring or bearing inner ring, an outer ring or bearing outer ring, and rolling elements between the inner and outer rings. In particular, at least substantially identical or structurally identical bearings are provided as the at least two bearings. The at least two bearings are in particular sealed so as to retain a lubricant provided in the planetary gear system. The at least two bearings enable stable mounting of the ring gear, whereby in-creased operational reliability and an extended service life of the drive can be achieved.

Typically, each of the at least two bearings comprises a bearing inner ring, wherein the bearing inner rings are arranged on the planet carrier, in particular on a cheek plate of the planet carrier. Typically, each of the at least two bearings comprises a bearing outer ring. The bearing outer ring can in each case be arranged so as to bear against the ring gear. The inner bearing ring and the outer bearing ring are typically each axially secured, for example, by means of a retaining ring.

As an alternative or in addition, it may be provided that the planet carrier has two cheek plates or a double cheek plate design. One of the at least two bearings can be arranged on both cheek plates or on each cheek plate of the planet carrier. The cheek plates can be connected to one another by way of at least one web and/or at least one planetary axle. For example, three planetary axles can connect the cheek plates. The sun gear and/or the planet gears are in particular arranged between the cheek plates. This provides the most symmetrical load distribution possible and can reduce wear of the bearings. Typically, the planet carrier bears the contact force absorbed by the bearings and transfers it to the vehicle.

As an alternative or in addition, it may be provided that at least one of the at least two bearings is arranged between two axial edges of the wheel, preferably regionally or completely therebetween. In this respect, one of the bearings or several or all of the bearings can be arranged between the two axial edges of the wheel, preferably regionally or completely. Preferably, a first axial center located between all bearings of the at least two bearings is situated between the two axial edges of the wheel. The first axial center refers in particular to an axial bearing center of gravity, which, for example, in the case of two bearings, is situated approximately in the middle between the two bearings.

As an alternative or in addition, it may be provided that the first axial center at least substantially coincides with a second axial center of the wheel, and preferably is positioned at most 40% or at most 20% or at most 10% of an axial width of the wheel away from the second center. In other words, for example, the bearing center of gravity should be situated approximately in the middle between the edges of the wheel or deviate therefrom by no more than a certain percentage of a wheel width.

For example, the bearing center of gravity or the center of the bearings is situated off-center, for example, between 40% and 80%, preferably between 50% and 70%, in particular between 60% and 65%, of the width of a contact patch of the wheel.

The width of the contact patch is typically defined by the distance between the edges of the wheel with respect to one another in the axial direction. The second axial center is situated, for example, in the middle of the width of the contact patch.

As an alternative or in addition, it may be provided that inner teeth of the ring gear are arranged in the axial direction between two bearings of the at least two bearings. The inner teeth can be arranged, preferably regionally or completely, between the two axial edges of the wheel. The planet gears can mesh with the inner teeth and/or with outer teeth of the sun gear between the two bearings of the at least two bearings, preferably regionally or completely therebetween. The planet gears can project in the radial direction between two of the at least two bearings and mesh with the ring gear between these two bearings.

The drive comprises an electromechanical brake. For example, the brake is configured to be/become released in an energized state and, preferably, to be blocked when the current is reduced all the way to the de-energized state. The brake is provided or configured to brake the sun gear and/or a drive shaft of the electric motor which provides the sun gear. In particular, the brake is operatively connected indirectly to the wheel via the planetary gear system and/or directly to the drive shaft or the sun gear. Typically, the brake is arranged coaxially with respect to the drive shaft, the sun gear, and/or the wheel.

The brake can be arranged in the axial direction opposite the electric motor. For example, the sun gear is arranged between the brake and the electric motor. The brake can be accommodated by an axial cut-out in the planetary gear system, in particular in the planet carrier, and/or by the wheel or a rim of the wheel, for example so as to be easily accessible for maintenance purposes and to keep the drive compact. The brake can be arranged so as to be accessible on the wheel side or away from the motor. The brake can be arranged on a side close to the wheel or away from the motor, and/or the planetary gear system can be arranged, for example, substantially or regionally, between the brake and the electric motor.

A rotor of the brake can be mounted to the drive shaft in a torque-transmitting manner or connected to the drive shaft in a torque-transmitting manner, for example with a driver or with a component of the drive shaft. In particular, the rotor is connected directly to the drive shaft. The rotor of the brake is preferably connected to the drive shaft or the sun gear in a form-locked manner. For example, a spline can be provided for torque transmission. For example, the rotor and the drive shaft can be bolted together.

As an alternative or in addition, the rotor can be connected to the drive shaft or the sun gear via a feather key connection in a torque-transmitting manner. For this purpose, the rotor of the brake and the drive shaft can each have a keyway into which a feather key is inserted. The feather key connection enables a connection with as little play as possible or no play at all, which is comparatively easy to produce.

The brake can be a spring-loaded brake or a spring-pressure brake. The rotor of the brake can have or carry one or more friction linings. The brake can have an anchor plate and at least one spring, for example a disk spring. The friction lining can be clamped between the anchor plate with the at least one spring and a flange, in particular a flange of the electric motor. The at least one spring can press against the anchor plate, in particular in a de-energized state of a coil. When the coil is energized, the anchor plate is pulled in against the spring force to release the rotor or friction lining.

As an alternative or in addition, it may be provided that the planet carrier is fixed relative to a/the motor housing and/or the brake or is fixed thereon, for example, is fastened to the motor housing and/or the brake or connected thereto, in particular is fastened or connected thereto by way of an end shield of the drive. For example, the planet carrier is connected to the motor housing or to the brake, preferably in each case directly or indirectly, for example bolted thereto or integrally formed therewith. The end shield is arranged, for example, between the planetary gear system and the motor and is in particular configured to mount a drive shaft. The end shield can be configured as a flange. For example, the planet carrier can be a substantially stationary part of the planetary gear system or the drive. In other words, for example, the planet carrier can be connected to the brake and/or the motor housing so as to be stationary.

As an alternative or in addition, it may be provided that the wheel surrounds the brake and/or that the brake is arranged between the two axial edges of the wheel, in particular in the axial cut-out. A hub cover can be provided to cover the brake. The hub cover can be fixed, in particular bolted, to a rim and/or to the planet carrier. In particular, the brake is located in the vicinity of the wheel and can be accessible from the outside. In other words, for example, a cover on the rim can enable the brake to be replaced for servicing. This design additionally protects the brake from external influences and reduces maintenance requirements.

As an alternative or in addition, it may be provided the ring gear has a contact surface that is in particular located on the outside. The contact surface is in particular provided for transmitting a vertical bearing load or radial load. The contact surface is preferably, at least in sections, cylindrically and/or convexly formed around the axis of rotation of the sun gear and/or is provided or designed for the connection to the wheel, in particular to a rim of the wheel, which can include a wheel tread. The contact surface can surround the at least two bearings and/or be arranged radially outside the at least two bearings. The contact surface provides a connection option for attaching the wheel and enables, for example, easy replacement.

The wheel can comprise a wheel tread and, in particular, a/the rim. The wheel or rim can be connected to the ring gear in a torque-transmitting manner. For example, a wheel tread can be applied to a/the rim, glued to the rim, and/or molded or vulcanized to or onto the rim. The wheel tread can be joined to the rim or the hollow wheel in a force-fit, integral, and/or form-locked manner, in particular directly or indirectly.

As an alternative or in addition, it may be provided that the wheel or a/the rim of the wheel has an inner surface that contacts the ring gear. The inner surface can have several protrusions that engage in the ring gear. The contact surface can have several protrusions that engage in the inner surface. The protrusions can provide a form fit for power transmission when a vehicle is being driven. The multiple protrusions can be formed monolithically with the inner surface or with the contact surface. The multiple protrusions preferably extend along an axial direction.

The object is furthermore achieved by the use of one drive or multiple drives as a wheel drive or wheel drives and/or wheel hub gear motors of a driverless transport vehicle, usually abbreviated as AGV or automated guide vehicle, in particular for driving the transport vehicle. The drive is or the multiple drives are in particular the drive described above. The use is thus characterized by the fact that the drive is mounted as a wheel drive on a driverless transport vehicle and is used in particular for driving purposes.

The object is furthermore achieved by a driverless transport vehicle comprising multiple drives, in particular comprising one or more of the above-described drives.

The transport vehicle can include a battery or driving battery which can store electrical energy. The drive can be connected to the battery in a current-transmitting manner.

To the extent that ordinal numbers, for example, “first,” “second,” and the like are used to designate a component or an element, these ordinal numbers serve solely the purpose of differentiation in the designation and do not indicate any dependencies or sequences. This means, in particular, that, for example, a device does not necessarily have to comprise a “first component” in order to be able to comprise a “second component.” A device can likewise comprise a “first component” and a “third component,” without necessarily comprising a “second component.” There may also be several units having the same ordinal number, for example, several “first components.”

Within the scope of the disclosure, the term “respectively” is used and is intended to indicate alternative, essentially equivalent and/or synonymous features or terms so as to clarify the idea or the meaning of the use of a feature or term. “Respectively” and “or” can always be replaced with “and/or.”

The invention will be described in more detail hereafter based on a preferred exemplary embodiment with reference to the drawings.

In the drawings:

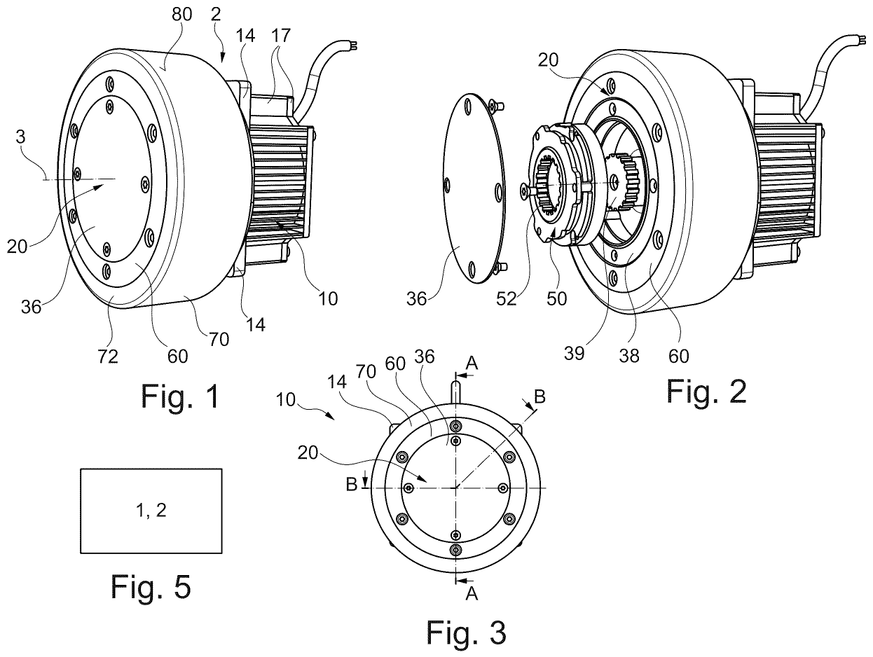

FIGS. 1-3 show a drive according to the invention in perspective views;

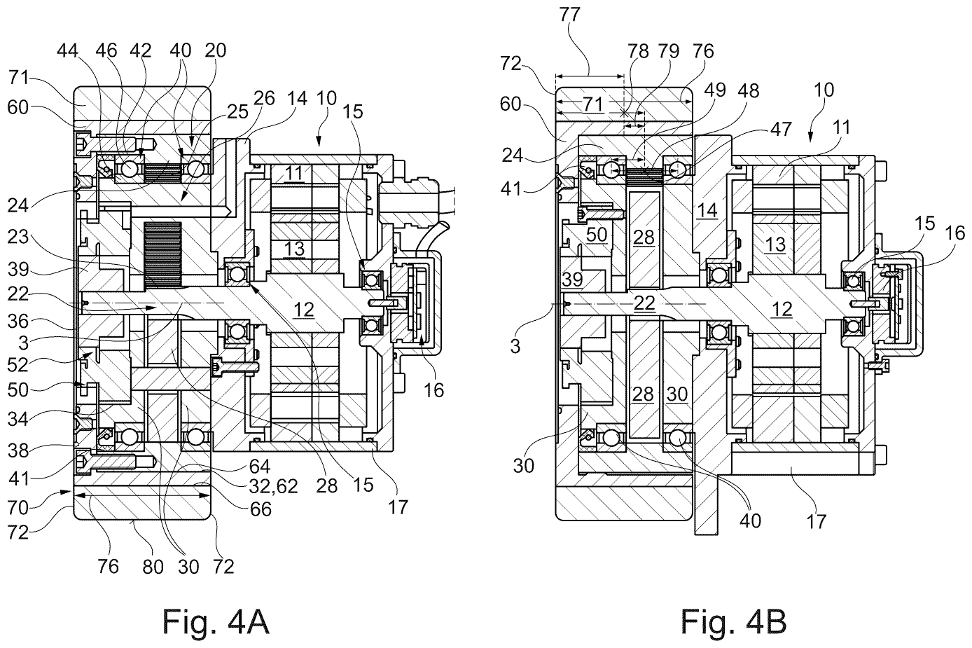

FIGS. 4A-B show the drive in sectional views, and

FIG. 5 shows a transport vehicle comprising drives in a schematic view.

Where identical reference signs are used in the figures, the following description applies accordingly to the figures among themselves. Described are examples which can be modified and/or supplemented in a variety of ways within the scope of the claims. Each feature that is described for a particular example can be used in-dependently of or in combination with other features, in any other example Each feature that is described for an example of a particular claim category may also be used in a corresponding manner in an exemplary embodiment, for example, another claim category or another aspect of the invention.

FIG. 1, FIG. 2, and FIG. 3 show a drive 2 or wheel hub gear motor for a wheel-driven vehicle 1. The drive 2 comprises an electric motor 10 including a motor housing 17 and a planetary gear system 20 that is connected to the electric motor 10, in particular by way of an end shield 14. Furthermore, a wheel 70 of the drive 2, which can make direct contact with the ground, is connected to the planetary gear system 20.

The wheel tread 71 of the wheel 70 borne by a rim 60 provides, between the wheels 72 thereof, an at least substantially cylindrical outer surface or running surface or a substantially smooth or profiled contact patch 80. An axis of rotation 3 of the drive 2 is to be aligned or is aligned at least substantially parallel to the ground.

An exploded view is shown with respect to FIG. 2, wherein a hub cover 36 to be fastened to the rim 60, in particular in a recess 38, is shown spaced apart from the rim 60. Furthermore, a brake 50 designed as a spring-loaded brake including a rotor 52 is shown spaced apart from the rim 60 or from the planetary gear system 20. The brake 50 is provided for fastening to a planet carrier 30 of the gear system, which is no shown in detail in FIG. 2. The rotor 52 is designed to form a form fit with a component 39 or a driver of the planetary gear system 20, so that an electrically switch-able braking process can be carried out to bring the gear system to a halt or fix it in the halted position. In the present example, the component 39 has outer teeth and the rotor 52 has inner teeth, wherein the teeth engage in one another for the transmission of torque around the axis of rotation 3. For the rotation about the axis of rotation 3, the component 39 is connected to a drive shaft 12 in a form-locked manner, in particular bolted thereto and/or mounted thereon.

The brake 50 is typically designed to be released in an energized state and to be blocked in a de-energized state, for example so that an emergency stop is carried out in the event of a power failure.

FIG. 3 shows a front view looking at the axis of rotation 3. It is apparent that the wheel 70 surrounds the planetary gear system 20. The wheel 70 includes a wheel tread 71, which is fixed directly to the rim 60, for example in a form-locked and/or force-fit manner, and in particular vulcanized thereon. The rim 60 is fixed directly to a ring gear 24, which is no shown in detail in FIG. 3, for example in a form-locked manner. The hub cover 36 covers the brake 50, which is not shown in detail in FIG. 3, and, in regions, the planetary gear system 20. Part of the end shield 14 of the motor 10 is apparent in the background, wherein the end shield 14 is fixed to the planetary gear system 20 and seals the same, in particular in an oil-tight manner.

FIG. 3 furthermore shows the sectional views, and more particularly the sectional view of FIG. 4A at A-A and the sectional view of FIG. 4B at B-B.

The drive 2 for a wheel-driven vehicle is shown in a sectional view in FIGS. 4A-B. The drive 2 comprises the planetary gear system 20, which comprises a sun gear 22, the ring gear 24, the planet carrier 26, as well as the planet gears 28 carried by the planet carrier 26 and meshing with the sun 22 and the ring gear 24.

The drive 2 furthermore comprises the electric motor 10 including a drive shaft 12 for driving the sun gear 22. The sun gear 22 is provided in one piece with the drive shaft 12. Furthermore, the component 39, which is in engagement with the rotor 52 of the brake 50, is non-rotatably connected to the drive shaft 12 or to the sun gear 22. In the present example, the drive shaft 12 is mounted so as to be rotatable about the axis of rotation 3 by way of at least one bearing 15, in particular rolling bearing, in the present example two bearings 15, in the motor housing 17 or in the end shield 14. One of the two bearings 15 is located in the axial direction substantially between the electric motor 10 and the planetary gear system 20.

A rotor 13, which surrounds the drive shaft 12 and can be caused to rotate by a stator 11 of the motor 10, is located in the electric motor 10. The rotor furthermore comprises a rotary encoder 16 which is operatively connected to the drive shaft 12.

It is apparent that the wheel 70 or the rim 60 is non-rotatably connected to the ring gear 24. More precisely, the wheel tread 71 is non-rotatably joined to the rim 60, and the rim is non-rotatably connected to the ring gear 24.

The drive comprises two bearings 40, which are used to mount the ring gear 24 to the planet carrier 26. Each of the two bearings 40 comprises an outer ring 42 resting against the ring gear 24, an inner ring 44 resting against the planet carrier 26, and rolling elements 46 arranged between the outer ring 42 and the inner ring 44, for example spherical rollers, balls, needles or the like.

The planet carrier 26 is designed with two cheek plates 30, with one of the two bearings 40 being arranged on the two cheek plates 30 of the planet carrier 26. More precisely, one of the inner rings 44 is in each case arranged on one of the cheek plates 30.

It is apparent that the two bearings 40 are arranged in a direction along the axis of rotation 3 between the two axial edges 72 of the wheel 70. In particular, a first axial center 47 located between all bearings of the two bearings 40 is situated between the two axial edges 72.

The first axial center 47 is arranged spaced apart from the two bearings 40 by a distance 49 which at least substantially corresponds to one half the distance 48 between the bearings 40. Two times the distance 49 yields the distance 48, for example.

The first axial center 47 substantially coincides with a second axial center 78 of the wheel 70. In the present example, the first 47 and the second 78 axial centers are spaced apart from one another along the axis of rotation 3 by a distance 79. The distances 79 corresponds to a portion of the axial width 79 of approximately 16% or no more than 20%. In other words, the first axial center 47 is positioned away from the second axial center 78 by no more than 20% of the axial width 76.

Along the axis of rotation 3, the second axial center 78 is located at a distance 77 with respect to the edge 72, which at least substantially corresponds to half the distance 76. Two times the distance 77 yields the distance 76, for example.

Inner teeth 25 of the ring gear 24 are arranged in the axial direction or along the axis of rotation 3 between the two bearings 40. Each of the planet gears 28 meshes with the inner teeth 25 and with outer teeth 23 of the sun gear 22 between the two bearings 40.

The electromechanical brake 50 is used for braking the sun gear 22 and the drive shaft 12 of the electric motor 12 which provides the sun gear 22. The brake 50 is arranged in the axial direction opposite the electric motor 10. The sun gear 22 is arranged between the brake 50 and the electric motor 10. The rotor 52 is mounted to the component 39 of the drive shaft 12 in a torque-transmitting manner.

The rotor 52 can be connected to the drive shaft 12, and in particular the component 39, by way of a feather key connection 39. The brake 50 or the rotor 52 is directly connected to the drive shaft 12 or the component 39.

The brake 50 is accommodated by an axial cut-out 34 of the planetary gear system 20, more precisely of the planet carrier 26. The brake 50 is accommodated by the rim 60.

The brake is surrounded by the wheel 70, and in particular by the wheel tread 71.

The planet carrier 26 is fixed relative to the motor housing 17 and to the brake 50, and in particular is fastened thereto, for example bolted thereto.

The wheel 70 surrounds the brake 50. The brake 50 is furthermore arranged between the two axial edges 72 of the wheel 70. The hub cover 36 is provided for covering the brake 50 and can be removed, for example for servicing the brake 50, and in particular can be taken out of the recess 38.

The ring gear 24 has a contact surface 32, which is shaped at least substantially cylindrically around the axis of rotation of the sun gear 22 and provided for the connection to the rim 60 of the wheel 70. The contact surface 32 surrounds the two bearings 40 and is arranged radially outside the two bearings 40.

The rim 60 has an inner surface 62 that contacts the ring gear 24 and has several protrusions 64 engaging in the ring gear 24. In the present example, the protrusions 64 extend across less than the entire axial width 76 of the rim 60, in particular across less than 50% of the axial width 76 of the rim 60.

The rim 60 has an outer surface 66, against which the wheel tread 71 rests directly and in particular in a power-transmitting manner.

In the present example, the rim 60 is mounted or placed onto the ring gear 24 in the axial direction, wherein the protrusions 64 provide a form fit, acting about the axis of rotation 3, between the rim 60 and the ring gear 24. It is apparent that the rim 60 is fixed, in particular bolted, to the ring gear 24 in the axial direction.

In the present example, the planetary gear system 20 is filled with a lubricant. In this respect, the drive 2 is designed to be regionally fluid-tight so as to keep the lubricant in the planetary gear system. For this purpose, on the one hand, a seal 41 is arranged between the rim 60 and one of the bearings 40. In the present example, the seal 41 adjoins one of the two bearings 40. On the other hand, the motor housing 14 is fixed sealingly to the planetary gear system 20, in particular by way of the end shield 14, wherein a rotary feedthrough for the drive shaft 12 is sealingly designed with one of the bearings 15.

FIG. 5 shows a driverless transport vehicle 1, which is equipped with several of the above-described drives 2, serving as wheel drives. The drives 2 are thus used as wheel drives, and more particularly in particular for driving the transport vehicle 1. Each of the drives 2 comprises a wheel, which is in contact with a ground. Electric motors of the drives 2, and in particular the motor housings thereof, are non-rotatably fixed to a chassis or the like of the transport vehicle 1. The drives 2 can be energized by a battery of the transport vehicle 1, on the one hand to release the brakes of the drives 2 and on the other hand for driving the transport vehicle 1.

Shown and described is a use of several drives 2 as wheel hub gear motors of a driverless transport vehicle 1. When the driverless transport vehicle 1 is being moved with its own resources, the drives 2 are used for driving the transport vehicle 1.

Shown and described are drives 2, and in particular hub gear motors, to the following applies, for example:

The bearings 40 or output bearings are arranged so that the center of the bearings 40 is located along the axis of rotation 3 between 60% and 70% of the width of the wheel contact patch or of the distance 76. In particular, the center of the two bearings 40 (see at reference numeral 48) is located at approximately 65% of the width of the wheel contact patch or of the distance 76, see FIGS. 4A-B.

Standard grooved ball bearings are used, and high vertical bearing loads or radial loads can be applied. A high radial load allows a high pressure force of the wheel 70 toward the ground, thereby creating shorter braking distances. This enables smaller protective field zones, and thus a higher travel speed of the transport vehicle 1 provided with the drive 2.

The output of the planetary gear system 20 is the ring gear 24, which is directly connected to the rim 60. A large radial installation space is being utilized by placing the rim 60 and the ring gear 24 inside one another in the axial direction.

The stationary planet carrier 26 is connected to the brake 50 in the region near the wheel or close to the wheel 70. The brake 50 can be replaced via a cover or the hub cover 36, even if the relevant drive 1 is installed in the ready-to-operate transport vehicle 1. This simplifies maintenance work. The drive 1 is designed for the use as a drive driving an AGV.

List of Reference Signs

| | |
|---|---|
| 1 | transport vehicle |
| 2 | drive |
| 3 | axis of rotation |
| 10 | electric motor |
| 11 | stator |
| 12 | drive shaft |
| 13 | rotor |
| 14 | end shield |
| 15 | bearing |
| 16 | rotary encoder |
| 17 | motor housing |
| 20 | planetary gear system |
| 22 | sun gear or sun gear system |
| 23 | outer teeth |
| 24 | ring gear |
| 25 | inner teeth |
| 26 | planet carrier |
| 28 | planet gear |
| 30 | cheek plate of the planet carrier |
| 32 | contact surface of the ring gear |
| 34 | axial cut-out |
| 36 | hub cover |
| 38 | recess |
| 39 | component |
| 40 | bearing |
| 41 | seal |
| 42 | outer ring |
| 44 | inner ring |
| 46 | rolling element |
| 47 | first center |
| 48 | distance |
| 49 | half distance |
| 50 | electromechanical brake |
| 52 | rotor of the brake |
| 60 | rim |
| 62 | inner surface |
| 64 | protrusion |
| 66 | outer surface |
| 70 | wheel |
| 71 | wheel tread |
| 72 | edge |
| 76 | width |
| 77 | half width |
| 78 | second center |
| 79 | distance |
| 80 | contact patch |

1. A drive for a wheel-driven vehicle, the drive comprising:
a planetary gear system including a sun gear, a ring gear, a planet carrier, and planet gears carried by the planet carrier and meshing with the sun gear and the ring gear;
an electric motor for driving the sun gear;
a wheel which is non-rotatably connected to the ring gear; and
an electromechanical brake for braking at least one of the sun gear and a drive shaft of the electric motor providing the sun gear, wherein
the sun gear being arranged between the brake and the electric motor and the brake is situated between two axial edges of the wheel.

2. The drive according to claim 1, comprising
at least two bearings for mounting the ring gear to the planet carrier.

3. The drive according to claim 2, wherein
the planet carrier is designed with two cheek plates, and one of the two bearings is arranged on the two cheek plates of the planet carrier.

4. The drive according to claim 2, wherein
at least one of the at least two bearings is arranged between the two axial edges of the wheel.

5. The drive according to claim 4, wherein
a first axial center located between all bearings of the at least two bearings is situated between the two axial edges of the wheel.

6. The drive according to claim 5, wherein
the first axial center at least substantially coincides with a second axial center of the wheel.

7. The drive according to claim 6, wherein the first axial center is positioned away from the second axial center by no more than 20% of an axial width of the wheel.

8. The drive according to claim 2, wherein
inner teeth of the ring gear are arranged in the axial direction between two bearings of the at least two bearings, and
each of the planet gears meshes with the inner teeth and with outer teeth of the sun gear between the two bearings of the at least two bearings.

9. The drive according to claim 1, wherein
a rotor of the brake is mounted to the drive shaft in a torque-transmitting manner.

10. The drive according to claim 1, wherein
a rotor of the brake is connected to the drive shaft by way of a feather key connection.

11. The drive according to claim 1, wherein
the planet carrier is fixed relative to at least one of a motor housing and the brake.

12. The drive according to claim 11, wherein the planet carrier is connected to at least one of the motor housing and to the brake.

13. The drive according to claim 1, wherein
the wheel surrounds the brake, and the brake is arranged between two axial edges of the wheel.

14. The drive according to claim 1, comprising
a hub cover for covering the brake.

15. The drive according to claim 2, wherein
the ring gear has a contact surface for transmitting a vertical bearing load, which is shaped at least regionally cylindrically around the axis of rotation of the sun gear and is provided for the connection to a rim of the wheel, and
the contact surface at least one of surrounds the at least two bearings and is arranged radially outside the at least two bearings.

16. The drive according to claim 1, wherein
at least one of the wheel and rim of the wheel has an inner surface contacting the ring gear;
the inner surface has a plurality of protrusions that engage in the ring gear; and
the protrusions extend across less than 50% of an axial width of the rim.

17. A driverless transport vehicle, comprising a plurality of drives according to claim 1.
